(19) United States
(12) Patent Application Publication
(10) Pub. No.: US 2004/0148733 A1
(43) Pub. Date: Aug. 5, 2004

(54) Door holder

(76) Inventor: George Wartian, Mt. Clemons, MI (US)

Correspondence Address: REISING, ETHINGTON, BARNES, KISSELLE, P.C., P O BOX 4390, TROY, MI, 48099-4390, US

(21) Appl. No.: 10/356,416

(22) Filed: Jan. 31, 2003

(51) Int. Cl. E05F 3/02

(52) U.S. Cl. 16/66

(57) ABSTRACT

A door holder has a piston reciprocable in a cylinder and a rod extending from the piston through one end of the cylinder. The outer end of the rod is pivoted to a door frame and the opposite end of the cylinder is pivoted to the door, or visa versa. A retainer is provided on the rod to prevent the piston and cylinder from contracting after the door has been opened. To release the retainer so that the piston and cylinder can contract, a coil spring is compressed between the retainer and the end of the cylinder. Upon a slight extension of the piston and cylinder beyond the door holding position, the spring pushes the retainer out of engagement with the cylinder so that the piston and cylinder can contract and the door can close.

This invention relates to door holders and more particularly to a door holder for holding a door in an open position.

### BACKGROUNG AND SUMMARY OF THE INVENTION

A typical door holder is a piston-cylinder assembly having a piston reciprocable in a cylinder and a rod extending from the piston through one end of the cylinder. The outer end of the rod is pivoted to a door frame and the opposite end of the cylinder is pivoted to the door, or visa versa. A retainer is provided on the rod to prevent the piston-cylinder assembly from contracting after it has been extended when the door is opened. The retainer has an aperture which is slidable on the rod and has a tab end which is engagable with the cylinder when the piston-cylinder assembly is extended and the retainer is tilted. In this tilted position, the retainer is cocked and the aperture in the retainer bites into the rod to hold the piston-cylinder assembly against contraction in a door holding position. When it is desired to release the door and allow it to close, the retainer must be manually retracted from engagement with the end of the cylinder so that the retainer uncocks and the door is free to close, contracting the piston-cylinder assembly and sliding the retainer along the rod.

It is a nuisance to have to reach down and disengage the retainer from the end of the cylinder in order to allow the piston-cylinder assembly to contract and the door to close. An object of this invention to make it easier to close the door after it has been held in a door holding position by the retainer, without the necessity of bending over and disengaging the retainer. This is accomplished in accordance with the present invention by a compressible release member which is compressed between the end of the cylinder and the retainer when the retainer is in the cocked position. The compressed release member is operable, upon a slight extension of the piston-cylinder assembly beyond the door holding position to uncock the retainer and permit the piston-cylinder assembly to contract and the door to close. Preferably the release member is in the form of a compression coil spring wound around the piston rod.

Other objects, features and advantages of the invention will become more apparent as this description proceeds, especially when considered in conjunction with the accompanying drawings.

### BRIEF DESCRIPTION OF THE DRAWINGS

FIG. 1 is a fragmentary perspective view showing a piston-cylinder assembly extending between a door and a door frame, including a retainer for holding the piston-cylinder assembly extended, and a compressible release member between the cylinder and the retainer, in accordance with the present invention;

FIG. 2 is a view similar to FIG. 1, but shows the door in an open position;

FIG. 3 is fragmentary elevational view showing a portion of the piston-cylinder assembly in which the retainer is slid up against the end of the cylinder to hold the piston-cylinder assembly against contracting, and with the compressible release member shown compressed between the end of the cylinder and the retainer;

FIG. 4 is a view similar to FIG. 3, but shows the position of the parts after the cylinder has been slightly extended to disengage the retainer which is shown having been pushed away by the release member.

### DETAILED DESCRIPTION OF THE PREFERRED EMBODIMENT

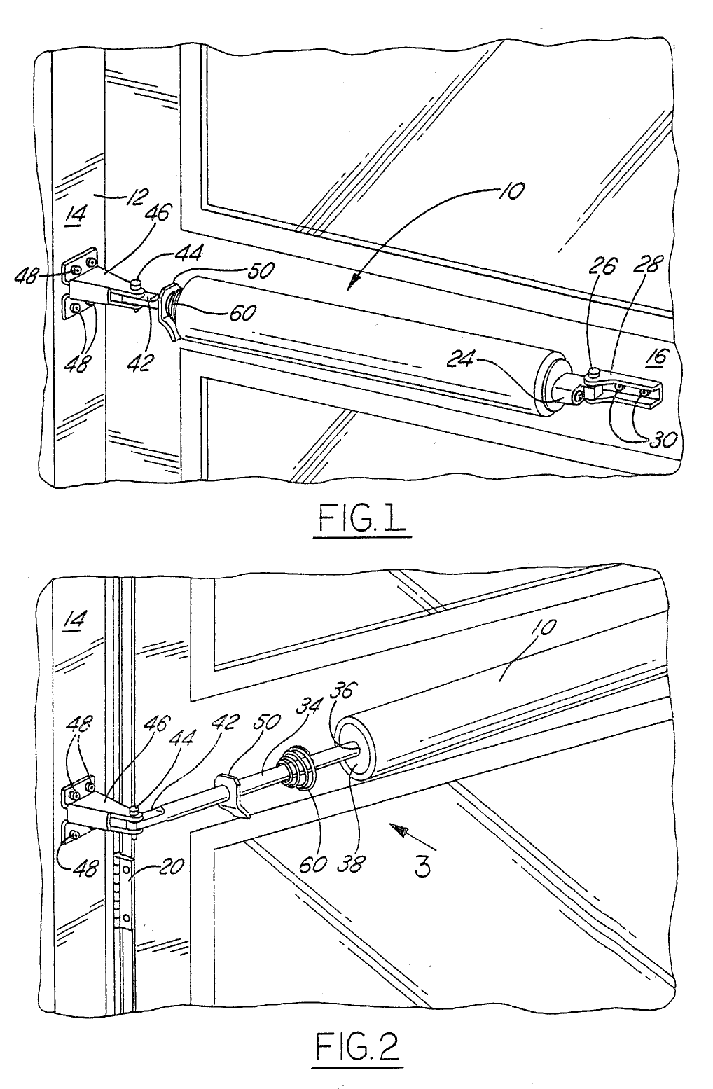

Referring now more particularly to the drawings, there is shown a piston-cylinder assembly 10 extending between a part 12 of a door frame 14 and a part 16 of a door 18. The door is mounted on the door frame 14 by hinges 20 for swinging movement between a closed position shown in FIG. 1 and an open or partially open position shown in FIG. 2.

The piston-cylinder assembly 10 includes an elongated cylinder 22 having an end 24 pivoted by a pin 26 to a bracket 28 secured by fasteners 30 to the part 16 of the door. A piston 32 is longitudinally reciprocable in the cylinder 22. A piston rod 34 is secured to the piston and extends slidably through an opening 36 in the end 38 of the cylinder. A compression coil spring 39 in the cylinder 22 presses against the piston 32 and the end 38 of the cylinder urging the piston-cylinder assembly 10 to a contracted position. An outer portion 40 of the rod 34 exteriorly of the cylinder has an end 42 pivoted by a pin 44 to a bracket 46 secured by fasteners 48 to the frame part 12.

A retainer 50 is provided to prevent the piston-cylinder assembly 10 from contracting after it has been extended when the door is at least partially opened, to hold the door in the open position. The retainer 50 has an aperture 52 slidably receiving the rod 34. The retainer has a tab 54 which is engagable with the end 38 of the cylinder when the piston-cylinder assembly 10 is extended and the retainer is tilted, to cause the retainer to assume a cocked position (FIG. 3) with the aperture 52 biting into the outer portion 40 of the piston rod, thereby holding the piston-cylinder assembly against contraction in a door holding position. The tilting of the retainer 50 is down manually, after the door 18 has been opened and the piston-cylinder assembly extended the desired amount. Then when the door is released, the tendency of the piston-cylinder assembly to contract is prevented by the tilted retainer to hold the door in the open position.

A compressible release member is longitudinally slidable on the rod 40 between the retainer 50 and the end 38 of the cylinder 22. The release member is preferably in the form of a coil spring 60. The coils 62 of the coil spring are wound around the piston rod 40. When the door 18 is held open by the retainer 50 in the position of FIG. 3, the coil spring 60 is compressed between the retainer 50 and the end 38 of the cylinder 22.

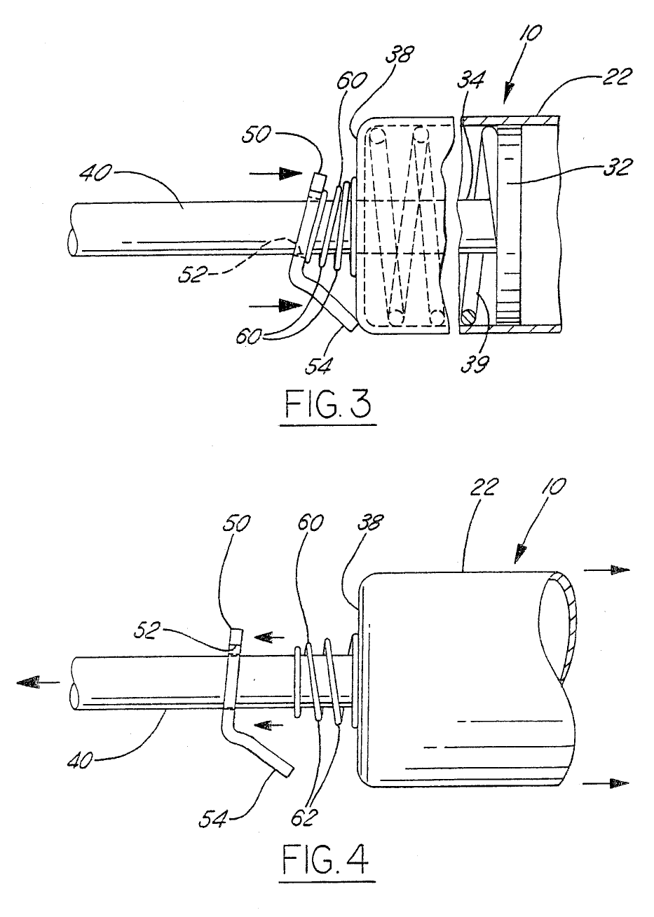

When it is desired to close the door 18 after being held open by the cocked retainer 50, the door is initially moved in an opening direction slightly beyond the door holding position of FIG. 3 to the position of FIG. 4, causing the spring 60 to push the retainer 50 away from the end 38 of the cylinder and out of engagement therewith, thereby releasing the piston-cylinder assembly 10 and allowing it to contract and the door to close. As the door closes and the piston-cylinder assembly 10 contracts, the retainer 50 is slid freely along the rod 34 by the coil spring 60 as it is pushed by the cylinder 22.

1. A door holder for releasably holding a door in an open position relative to a door frame comprising:
a piston-cylinder assembly including an elongated cylinder;
a piston reciprocable longitudinally in said cylinder;
a rod in said cylinder having a first end connected to said piston;
said rod extending slidably through a first end of the cylinder and having an outer portion exteriorly of the cylinder provided with a second end;
said piston-cylinder assembly being adapted to be positioned between a part of the door frame and a part of the door with the second end of the rod connected to one of the parts and a second end of the cylinder connected to another of said parts so that when the door is opened the piston-cylinder assembly is extended and when the door is closed the piston-cylinder assembly is contracted;
a spring in said cylinder urging said piston-cylinder assembly to a contracted position;
a retainer having an aperture slidably receiving the outer portion of said rod;
said retainer having a tab end which is engagable with the first end of the cylinder when the piston-cylinder assembly is extended and the retainer is tilted, to cause said retainer to assume a cocked position biting into said outer portion of the rod, thereby retaining the piston-cylinder assembly against contraction in a door holding position; and
a compressible release member compressed between the first end of the cylinder and said retainer when the retainer is in the cocked position, the compressed release member being operable, upon slight extension of the piston-cylinder assembly beyond the door holding position to uncock the retainer and permit the piston-cylinder assembly to contract and the door to close.

2. The door holder of claim 1 wherein said release member comprises a compression coil spring having coils wound around the outer portion of said rod.
